(19) United States
(12) Patent Application Publication
(10) Pub. No.: US 2025/0315843 A1
(43) Pub. Date: Oct. 9, 2025

(54) SYSTEM AND METHOD FOR VERIFYING AUTHENTICITY OF PRODUCTS AND GOODS USING RFID CHIPS

(71) Applicant: Richard WARTHER, West Chester, PA (US)

(72) Inventor: Richard WARTHER, West Chester, PA (US)

(21) Appl. No.: 19/174,562

(22) Filed: Apr. 9, 2025

Related U.S. Application Data
(60) Provisional application No. 63/631,817, filed on Apr. 9, 2024.

(51) Int. Cl. G06Q 30/018; G06K 19/07

(52) U.S. Cl. CPC G06Q 30/0185; G06K 19/0723

(57) ABSTRACT

A system for verifying authenticity of products or goods includes a wireless inlay having an antenna, a chip operably connected to the antenna and having an inlay memory, a unique identification number unalterably stored in the inlay memory, and a unique prestored authentication number stored in the inlay memory. The prestored authentication number is previously generated by applying a unique function to the identification number. The system further includes a wireless reader. The reader is configured to obtain the identification number from the inlay via the antenna, apply the unique function to the obtained identification number to produce a generated authentication number, obtain the prestored authentication number from the inlay via the antenna, and determine whether the prestored authentication number obtained from the inlay matches the generated authentication number.

### CROSS-REFERENCE TO RELATED APPLICATIONS

This application claims the benefit of U.S. Provisional Patent Application No. 63/631,817, filed Apr. 9, 2024, entitled “System and Method for Verifying Authenticity of Products and Goods Using RFID Chips,” the entire contents of which are incorporated by reference herein.

### BACKGROUND

Embodiments described herein relate generally to anti-counterfeiting efforts, and more particularly, to systems and methods for effectively verifying the authenticity of products and goods using RFID chips without being required to communicate with an external host database.

RFID inlays are typically used for inventory control and tracking. Unique identification data may be stored into memory of the inlay, typically within the Electronic Product Code (EPC) memory thereof. An RFID reader may interrogate the inlay via antenna to receive the data stored in the EPC. The reader then transmits the received data to a tracking database to evaluate and take further action. The database is often remotely stored and must be accessed by the reader over a network, such as the Internet.

Separately, there is a need to authenticate products to prevent counterfeiting. This is of particular concern in the pharmaceutical industry as counterfeit drugs passed off as authentic can be ineffective at best and downright dangerous at worst. Such counterfeits may contain no active ingredients, incorrect amounts or ingredients, and/or dangerous contaminants.

It is therefore desirable to provide systems and methods for asset tracking using RFID chips that may also be used to authenticate products and goods but without requiring external communication to a host database or other network connection.

### BRIEF SUMMARY

Briefly stated, one example embodiment comprises a system for verifying authenticity of products or goods. The system includes a wireless inlay having an antenna, a chip operably connected to the antenna and having an inlay memory, a unique identification number unalterably stored in the inlay memory, and a unique prestored authentication number stored in the inlay memory. The prestored authentication number is previously generated by applying a unique function to the identification number. The system further includes a wireless reader. The reader is configured to obtain the identification number from the inlay via the antenna, apply the unique function to the obtained identification number to produce a generated authentication number, obtain the prestored authentication number from the inlay via the antenna, and determine whether the prestored authentication number obtained from the inlay matches the generated authentication number.

In one aspect, the inlay memory includes a read-only memory (ROM) and an electronic product code (EPC) memory. In a further aspect, the identification number is stored in the ROM of the inlay memory. In a still further aspect, the prestored authentication number is stored in the EPC memory of the inlay memory.

In another aspect, the unique function is a variation of a mod operation. In a further aspect, the mod operation is one of a mod 10 operation, a mod 34 operation, or a mod 43 operation.

In yet another aspect the wireless reader includes a reader memory configured to store the unique function.

In still another aspect, the chip is an RFID chip and the wireless reader is an RFID reader.

Another example embodiment comprises a system for providing a unique prestored authentication number for authenticity verification of products or goods. The system includes a wireless inlay having an antenna, a chip operably connected to the antenna and having an inlay memory, and a unique identification number unalterably stored in the inlay memory. The system further includes a wireless reader/writer. The reader/writer is configured to obtain the identification number from the inlay via the antenna, apply a unique function to the obtained identification number to obtain a unique authentication number, and write the authentication number to the inlay memory.

In one aspect, the inlay memory includes a read-only memory (ROM) and an electronic product code (EPC) memory. In a further aspect, the identification number is stored in the ROM of the inlay memory. In a still further aspect, the wireless reader/writer is configured to write the authentication number to the EPC memory of the inlay memory.

In another aspect, the unique function is a variation of a mod operation. In a further aspect, the mod operation is one of a mod 10 operation, a mod 34 operation, or a mod 43 operation.

In yet another aspect, the chip is an RFID chip and the wireless reader/writer is an RFID reader/writer.

Still another example embodiment comprises a method for verifying authenticity of products or goods. Each product or good has a wireless inlay. Each inlay includes an antenna, a chip operably connected to the antenna and having an inlay memory, a unique identification number unalterably stored in the inlay memory, and a unique prestored authentication number stored in the inlay memory. The prestored authentication number is previously generated by applying a unique function to the identification number. The method includes obtaining, by a wireless reader, the identification number from the inlay via the antenna, applying, by the wireless reader, the unique function to the obtained identification number to produce a generated authentication number, obtaining, by the wireless reader, the prestored authentication number from the inlay, and determining, by the wireless reader, whether the prestored authentication number obtained from the inlay matches the generated authentication number.

In one aspect, the unique function is a variation of a mod operation. In a further aspect, the mod operation is one of a mod 10 operation, a mod 34 operation, or a mod 43 operation.

In another aspect, the method further includes storing, in a memory of the reader, the unique function.

### BRIEF DESCRIPTION OF THE SEVERAL VIEWS OF THE DRAWINGS

The following detailed description of preferred embodiments will be better understood when read in conjunction with the appended drawings. For the purpose of illustration, there are shown in the drawings embodiments which are presently preferred. It should be understood, however, that the invention is not limited to the precise arrangements and instrumentalities shown.

In the drawings:

FIG. 1 is a schematic block diagram of an RFID inlay and programming system in accordance with an example embodiment of the invention;

FIG. 2 is a schematic block diagram of the RFID inlay of FIG. 1 in use in product tracking and authentication in accordance with an example embodiment;

FIG. 3 is a schematic flow diagram showing an example transformation of a tag identification (TID) number of the RFID inlay into an authentication number to be stored by the RFID inlay;

FIG. 4 is a flow chart illustrating an example method for programming the RFID inlay of FIG. 1 for authentication; and

FIG. 5 is a flow chart illustrating an example method for authenticating the product bearing the RFID inlay of FIG. 1.

### DETAILED DESCRIPTION

Certain terminology is used in the following description for convenience only and is not limiting. The words “right”, “left”, “lower”, and “upper” designate directions in the drawings to which reference is made. The words “inwardly” and “outwardly” refer to directions toward and away from, respectively, the geometric center of the device and designated parts thereof. The terminology includes the above-listed words, derivatives thereof, and words of similar import. Additionally, the words “a” and “an”, as used in the claims and in the corresponding portions of the specification, mean “at least one.”

It should also be understood that the terms “about,” “approximately,” “generally,” “substantially” and like terms, used herein when referring to a dimension or characteristic of a component, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

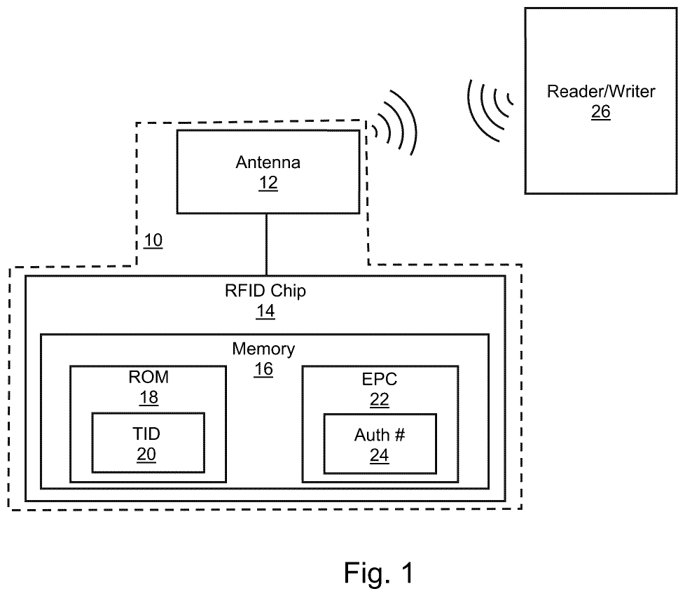

Referring to FIG. 1, there is shown an example RFID inlay 10 that may be configured to transmit an electro/magnetic signal containing at least a unique, electro/magnetic code and other, related information in response to an externally transmitted, radio frequency (“RF”) interrogation signal. The RFID inlay 10 may include one or more antennas 12 operably connected to an RFID chip 14. The RFID chip 14 may be, for example, an EPC Class 1 Gen 2 RFID Tag IC that may be operable in the Ultra High frequency (UHF) spectrum (e.g., 860-960 MHz), although other types of chips and frequencies may be used as well.

The RFID chip 14 may have a memory 16 that may include programmable and non-programmable nonvolatile memories or regions. For example, the memory 16 may include a read-only memory (ROM) 18 that is programmed or written with a TID 20. The TID 20 may be a unique serial number written to the RFID chip 14 when manufactured and that cannot be altered. For example, the TID 20 may be etched directly into the silicon of the RFID chip 14 to prevent electronic modification. However, other methods of storing a TID 20 into a non-alterable ROM 18 may be used as well. The TID 20 may have a size of 64 bits, although other sizes may be used as well.

The memory 16 may also include a programmable EPC memory 22, which may have between 96 and 480 bits of space, although more or less may be used as necessary. The EPC memory 22 may be programmable to store an EPC or other codes. In particular, the EPC memory 22 in FIG. 1 may store an authentication number 24, which may also serve as an EPC, but which may be used for authentication methods described in more detail below. Although FIG. 1 shows the authentication number 24 being stored in the EPC memory 22, it may alternatively be stored in other sections of the memory 16. The memory 16 may further include other memories or regions, such as reserved memory, user memory, combinations thereof, or the like, for use in conventional fashion.

An RFID reader/writer 26 may be provided to read data from the RFID chip 14 and/or to write appropriate data into the memory 16, including the authentication number 24 into the EPC memory 22 or other section of the memory 16. As will be described in further detail below, the reader/writer 26 may be used to acquire the TID 20 from the ROM 18 in the RFID chip 14, generate the authentication number 24 using the TID 20, and write the resulting authentication number 24 into the EPC memory 22 of the RFID chip 14. While it is anticipated that these operations may be performed by a single RFID reader/writer 26 such as that shown in FIG. 1, it is expected that the operations may be carried out among multiple devices, such as a dedicated RFID reader and separate RFID writer, and/or that writing to the RFID chip 14 may be performed using other data writing methods altogether.

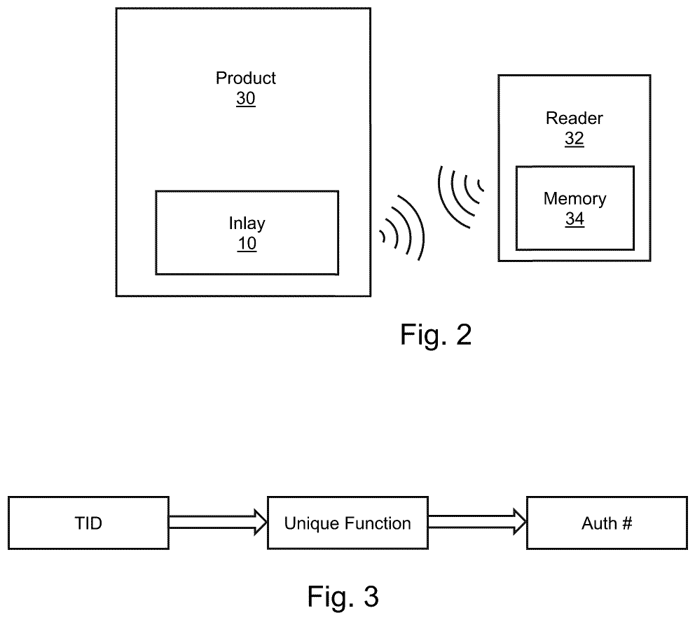

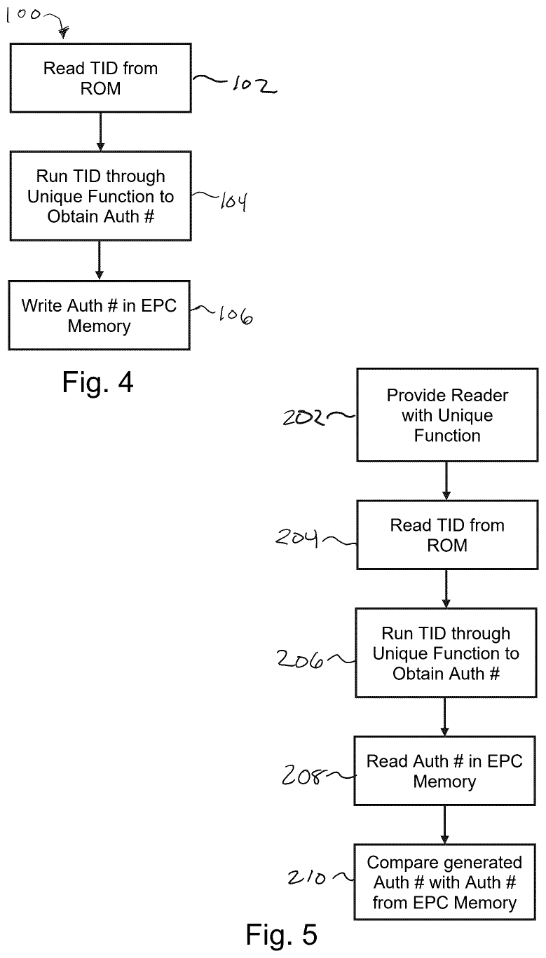

FIG. 4 shows an example method 100 for generating and writing the authentication number 24 to the inlay 10. In the context of the system shown in FIG. 1, at step 102, the reader/writer 26 may read the unique TID 20 from the ROM 18 of the inlay 10. At step 104, the reader/writer 26 (or potentially a computing device (not shown) in communication therewith) may run the obtained TID 20 through a unique function to obtain the authentication number 24 (see e.g., FIG. 3). For example, the unique function may be a check digit formula or other algorithm which is capable of generating a unique value upon application to the TID 20. In some examples, a custom mod 10, mod 34, mod 43, or like algorithm may be applied to the TID 20 to obtain a unique authentication number 24. The authentication number 24 may be the entire resulting number calculated from the unique function, or may be a lesser number of digits therefrom (e.g., the last four digits of the calculation result or the like). The unique function is preferably specific to a manufacturer or other seller of a product 30 (FIG. 2) with which the inlay 10 is to be used. As will be explained in further detail below, this enables the subsequent authentication check to occur without the need to call out to a remote network database or the like.

At step 106, the reader/writer 26 may write the authentication number 24 to the EPC memory 22 or other location in the memory 16 of the RFID chip 14. In some embodiments, the reader/writer 26 that acquired the TID 20 may be different than the reader/writer 26 that writes the authentication number 24 to the inlay 10. For example, the acquiring device may only have reader functions. In some examples, a first reader/writer 26 or the like may perform step 102. The TID 20 may be sent to a centralized facility for generation of the authentication number 24, which is then sent to a second reader/writer 26 (or possibly to the first reader/writer 26) for writing to the inlay 10. The various steps of the method 100 disclosed in FIG. 4 can therefore be performed by various components and entities, as desired.

FIG. 2 shows an example of the inlay 10 in use for asset tracking and authentication. The inlay 10 may be placed on, embedded in, or otherwise attached to the product 30. In one example, the product 30 may be a pharmaceutical container, although any type of container, packaging, device, item, or the like which is to be tracked and authenticated may be used as the product 30 bearing the inlay 10. For tracking and authenticating, a reader 32 may be utilized to interrogate the inlay 10, as will be explained in further detail below. Generating and/or writing the authentication number 24 to the inlay 10 may be performed by the manufacturer or other seller of the product 30, such as when asset tracking assignments of the inlay 10 are performed. Similarly, the generating and/or writing of the authentication number 24 may be performed before or after the inlay 10 is joined with the product 30.

The reader 32 may include a memory 34 in which the unique function, an inverse of the unique function, or the like may be stored for authenticating the inlay 10 provided with the product 30. However, the memory 34 may not be internal to the reader 32 as shown in FIG. 2, but the reader 32 may be in communication with an external computing device (not shown) that can store the necessary data. FIG. 5 shows one example method 200 for authenticating the product 30. In this example, at step 202, a reader 32 with the unique function stored in memory 34 may be provided. For example, the manufacturer or other seller of the product 30 associated with the unique function may provide a pre-programmed reader 32 to a distributor, wholesaler, user, or the like of the product 30 to track and authenticate the product 30 prior to distribution, sale, use, or the like. For example, a pharmacist may be provided with a reader 32 by a pharmaceutical company providing medication for distribution by the pharmacy. The unique function may, for example, be programmed in firmware, stored in ROM, or the like. In another example, the manufacturer or other seller may provide the unique function to authorized distributors, wholesalers, users, or the like via a secure download from a website or via physical media so that a previously-owned reader 32 may be programmed for authenticating the product 30.

At step 204, the reader 32 may read the unique TID 20 from the ROM 18 of the inlay 10. At step 206, the reader 32 (or other computing device in communication therewith) may run the obtained TID 20 through the unique function to obtain a generated authentication number, similar to the process described earlier when programming the inlay 10. At step 208, the reader 32 may read the authentication number 24 stored in the EPC memory 22 (or other memory) of the inlay 10. Although shown in FIG. 5 as occurring after generating an authentication number in the reader 32, step 208 may be performed contemporaneously with step 204 when the TID 20 is acquired. The particular timing and sequence of reading the TID 20 and the authentication number 24 from the inlay 10 relative to one another is not critical to the method. At step 210, the reader 32 may compare the authentication number 24 read from the inlay 10 with the authentication number generated from the obtained TID 20. If there is a match, the reader 32 (or connected computing device) may indicate that the product 30 has been authenticated Otherwise, an indication may be provided that there is a problem with the authentication so that appropriate steps may be taken to either further verify the authenticity of the product 30, discard the product 30, or the like.

In a similar example, the reader 32 may be programmed with an inverse of the unique function. The reader 32 may read the authentication number 24 stored in the inlay 10, run the acquired authentication number 24 to generate a TID, and compare the generated TID with the TID 20 read from the inlay 10.

By utilizing a reader 32 that is pre-programmed with the same unique function (or inverse or other variation to derive the connection between the TID 20 and the stored authentication number 24), the product 30 can be authenticated using only the asset tracking information from the inlay 10 and the unique TID 20. In this manner, the reader 32 does not have to access the Internet or another network to communicate with a host database for authentication. This avoids the potential for misdirection to a false database or one that may be compromised. It also allows for authentication to occur in situations where communication with the network may be unavailable, ensuring timely and accurate results.

Those skilled in the art will recognize that boundaries between the above-described operations are merely illustrative. The multiple operations may be combined into a single operation, a single operation may be distributed in additional operations and operations may be executed at least partially overlapping in time. Further, alternative embodiments may include multiple instances of a particular operation, and the order of operations may be altered in various other embodiments.

While specific and distinct embodiments have been shown in the drawings, various individual elements or combinations of elements from the different embodiments may be combined with one another while in keeping with the spirit and scope of the invention. Thus, an individual feature described herein only with respect to one embodiment should not be construed as being incompatible with other embodiments described herein or otherwise encompassed by the invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined herein.

I claim:

1. A system for verifying authenticity of products or goods, the system comprising:
a wireless inlay comprising:
an antenna,
a chip operably connected to the antenna and having an inlay memory,
a unique identification number unalterably stored in the inlay memory, and
a unique prestored authentication number stored in the inlay memory, the prestored authentication number having been previously generated by applying a unique function to the identification number; and
a wireless reader, the reader being configured to:
obtain the identification number from the inlay via the antenna,
apply the unique function to the obtained identification number to produce a generated authentication number,
obtain the prestored authentication number from the inlay via the antenna, and
determine whether the prestored authentication number obtained from the inlay matches the generated authentication number.

2. The system of claim 1, wherein the inlay memory includes a read-only memory (ROM) and an electronic product code (EPC) memory.

3. The system of claim 2, wherein the identification number is stored in the ROM of the inlay memory.

4. The system of claim 2, wherein the prestored authentication number is stored in the EPC memory of the inlay memory.

5. The system of claim 1, wherein the unique function is a variation of a mod operation.

6. The system of claim 5, wherein the mod operation is one of a mod 10 operation, a mod 34 operation, or a mod 43 operation.

7. The system of claim 1, wherein the wireless reader includes a reader memory configured to store the unique function.

8. The system of claim 1, wherein the chip is an RFID chip and the wireless reader is an RFID reader.

9. A system for providing a unique prestored authentication number for authenticity verification of products or goods, the system comprising:
a wireless inlay comprising:
an antenna,
a chip operably connected to the antenna and having an inlay memory, and
a unique identification number unalterably stored in the inlay memory; and
a wireless reader/writer, the reader/writer being configured to:
obtain the identification number from the inlay via the antenna,
apply a unique function to the obtained identification number to obtain a unique authentication number, and
write the authentication number to the inlay memory.

10. The system of claim 9, wherein the inlay memory includes a read-only memory (ROM) and an electronic product code (EPC) memory.

11. The system of claim 10, wherein the identification number is stored in the ROM of the inlay memory.

12. The system of claim 10, wherein the wireless reader/writer is configured to write the authentication number to the EPC memory of the inlay memory.

13. The system of claim 9, wherein the unique function is a variation of a mod operation.

14. The system of claim 13, wherein the mod operation is one of a mod 10 operation, a mod 34 operation, or a mod 43 operation.

15. The system of claim 9, wherein the chip is an RFID chip and the wireless reader/writer is an RFID reader/writer.

16. A method for verifying authenticity of products or goods, each product or good having a wireless inlay, each inlay including an antenna, a chip operably connected to the antenna and having an inlay memory, a unique identification number unalterably stored in the inlay memory, and a unique prestored authentication number stored in the inlay memory, the prestored authentication number having been previously generated by applying a unique function to the identification number, the method comprising:
obtaining, by a wireless reader, the identification number from the inlay via the antenna;
applying, by the wireless reader, the unique function to the obtained identification number to produce a generated authentication number;
obtaining, by the wireless reader, the prestored authentication number from the inlay; and
determining, by the wireless reader, whether the prestored authentication number obtained from the inlay matches the generated authentication number.

17. The method of claim 16, wherein the unique function is a variation of a mod operation.

18. The method of claim 17, wherein the mod operation is one of a mod 10 operation, a mod 34 operation, or a mod 43 operation.

19. The method of claim 16, further comprising storing, in a memory of the reader, the unique function.
